(19) United States
(12) Patent Application Publication
(10) Pub. No.: US 2011/0210170 A1
(43) Pub. Date: Sep. 1, 2011

(54) DIGITAL BARCODE USE, DISTRIBUTION, AND REDEMPTION SYSTEM FOR MOBILE DEVICES

(76) Inventor: DJ Arguello, Scottsdale, AZ (US)

(21) Appl. No.: 13/106,260

(22) Filed: May 12, 2011

Related U.S. Application Data
(63) Continuation-in-part of application No. 12/388,351, filed on Feb. 18, 2009.
(60) Provisional application No. 61/345,002, filed on May 14, 2010.

(51) Int. Cl. G06K 5/00

(52) U.S. Cl. 235/380

(57) ABSTRACT

A method of displaying an image with a display screen of an electronic device includes establishing communication between the electronic device and an application server. The application server is in communication with a database corresponding with information regarding a value item. The method includes flowing the information regarding the value item to the electronic device. A barcode image associated with the value item is displayed by the display screen. The barcode image is adjusted in response to an indication of the type of electronic device.

### CROSS-REFERENCE TO RELATED APPLICATIONS

This application claims priority to U.S. Provisional Application No. 61/345,002, filed on May 14, 2010, the contents of which are incorporated by reference as though fully set forth herein. This application is a continuation-in-part of 12/388,351, filed on Feb. 18, 2009 by the same inventor, the contents of which are incorporated by reference as though fully set forth herein.

### BACKGROUND OF THE INVENTION

1. Field of the Invention

This invention relates generally to a modular system and method of use, displaying, and distributing a digital barcode on/to a mobile device for the purposes of payment/discounts.

2. Description of the Related Art

Many retailers and credit issuing financial institutions utilize coupons, prepaid vouchers, and gift cards to attract and reward customers. A typical coupon, voucher, or gift card includes many different types of indicia, such as a redeemable value as well as a corresponding bar code. The bar code can be read by a scanning device, such as a bar code reader. This barcode then is used to interpret information off the coupon, voucher, or gift card through a point of sale system. More information regarding scanning devices, bar codes, and bar code readers can be found in U.S. Pat. Nos. 5,780,832, 5,689,103, 5,537,431, 5,440,110, 4,963,719 and 5,311,000, as well as in U.S. Patent Application No. 20030233276, the contents of all of which are incorporated herein by reference.

Additionally, many credit issuing financial institutions issue consumers with credit cards. A typical credit card includes many different types of indicia, such as brand, account holders name, expiration date, account/pseudo-account number, and security code. Most credit cards are comprised of plastic and have magnetic stripes and contactless radio frequency identification chips embedded in them as means of delivering account information securely through a credit card reader to a merchant's point of sale systems for payment. More information regarding credit cards, credit card readers, magnetic stripes, radio frequency identifier chips, and point of sale systems can be found in U.S. Pat. Nos. 3,762,081, 5,870,155, 7,156,301, 6,944,782, and 6,546,441, the contents of all of which are incorporated herein by reference.

Most coupons, prepaid vouchers, gift cards, and credit cards are provided in hardcopy form, wherein the indicia is printed on paper or plastic. For example, coupon's bar code and UPC code are typically printed on the paper. Prepaid vouchers and gift cards bar code and UPC code are typically printed or embossed in plastic. Similarly, credit cards magnetic stripe and radio frequency identifiers are printed or embossed in plastic. However, printing and embossing a large number of coupons, prepaid vouchers, gift cards, and credit cards on paper or plastic uses a large amount of resources, and leads to waste if they are not used.

Other coupons, vouchers, gift cards, and credit cards are displayed as a softcopy by a display screen of an electronic device. The electronic device can be of many different types, such as a mobile device having a display screen. Examples of mobile devices include cell phones, laptops, slate computers, and personal digital assistants. A softcopy of the coupon eliminates the need to print it or emboss it on the paper or plastic, which reduces the amount of resources used, as well as the amount of waste. More information regarding systems and methods which utilize coupons, vouchers, gift cards, and credit cards in softcopy form can be found in U.S. Pat. Nos. 5,930,767, 7,343,319, 6,370,514 as well as in U.S. Patent Application Nos. 20020004746, 20020040316, 20020042774, 20020055906, 20020060246, 20020161640, 20020161708, 20040024638 and 20080270243, the contents of all of which are incorporated herein by reference.

It is highly desirable to be able to scan the softcopy of the coupon, voucher, gift card, or credit card with the scanning device, such as the bar code reader. In particular, it is highly desirable to scan the softcopy of the coupon, voucher, gift card, or credit card with the scanning device when the softcopy of the coupon, voucher, gift card, or credit card is represented as a barcode and displayed by the display screen of the electronic device.

It is known that, in general, different electronic devices have display screens with different resolutions. It is also known that the accuracy of the scanning device depends on the resolution of the bar code that is displayed. Hence, if a soft copy of the bar code is displayed with a resolution that is too low, the scanner may have difficulty reading it. Thus, what is needed is a system and method for displaying a softcopy of a bar code so that the scanning device is more likely to be able to read the bar code.

### SUMMARY OF THE INVENTION

The present invention is directed to a barcode use, redemption, and distribution system. The novel features of the invention are set forth with particularity in the appended claims. The invention will be best understood from the following description when read in conjunction with the accompanying drawings.

### BRIEF DESCRIPTION OF THE DRAWINGS

FIG. 1a is a flow diagram of a method of displaying an image with a display screen of an electronic device, wherein the image corresponds to a coupon.

FIG. 1b is a flow diagram of a method of displaying an image with a display screen of an electronic device, wherein the image corresponds to a value item.

FIG. 1c is a flow diagram of a method of displaying an image with a display screen of an electronic device, wherein the image corresponds to a credit card.

### DETAILED DESCRIPTION OF THE INVENTION

In general, the imaging requirements for displaying a softcopy of a bar code are as follows. At a minimum one barcode image will be sized and displayed for redemption on the web enabled mobile devices screen. Barcode image should be displayed at a resolution such that there is a distinguishable break between adjacent bars or within the barcode matrix. It is desirable for the magnification factor to be such that the barcodes X-Dimension is displayed smaller than 3 mils (i.e. 3/1000 of an inch). This is because, for most scanning devices, the smallest supported X-Dimension is 3 mils or 3/1000 inch. The X-Dimension is the measurement of the narrowest bar in a barcode. It is measured in mils, wherein 1 mil= 1/1000th of an inch. The Magnification Factor is the stretch, skew, or zoom of an image measured in percentage. An image at true size is to be at 100% Magnification Factor.

The physical Width/Height of the displayed bar code image is dependant on the barcode encoding type and electronic devices operating system, display screen size, and display screen resolution, among other factors. The barcode image should be displayed on a display screen in such a way that the full image is visible so that the scanning device can read the barcode. Further, the barcode image should be displayed in such a way as to maintain the images integrity and reduce the amount of breaks and/or pixilation in the barcode lines or patterns.

There are many different barcode types that are currently used. These barcode types are generally categorized as being 1-dimensional and 2-dimensional types. Examples of 1-dimensional and 2-dimensional types are provided as follows:

### Examples of Bar Code Types:

| 1 Dimensional Types: | 2 Dimensional Types: |
|---|---|
| Codabar | Data Matrix |
| Code 128 | PDF 417 |
| Code 25 | Micro PDF 417 |
| Code 39 | Samsung PDF 417 |
| Code 93 | RSS 14 |
| EAN 128 | RSS Expanded |
| EAN 13 | RSS Limited |
| EAN | |
| JAN | |
| JAN | |
| Plessey | |
| Telepen | |
| UPC A | |
| UPC E | |

There are many different scanning devices that are currently used to scan barcodes. These scanning devices are provided as follows:

Examples of Compatible Barcode Reader Types:
Charged Couple Device (CCD)
Linear Imager
Long Range CCD
Area Imager

The invention provides a digital coupon, voucher, gift card, or credit card redemption system for distributing a softcopy of the coupon, voucher, gift card, or credit card to a desired electronic device. The system generally includes one or more computers in communication with each other, as well as data communication networks such as the Internet (i.e. the Web) or intranets. It should be noted that data communication networks allows the transmission of data from one computer to another, wherein the data is typically in digital form. Additionally, data communication networks encompass all direct and indirect forms of wireless communication including but not limited to radio, laser, and infrared channels. The computer(s) are also in communication with the electronic device through the one or many data communication networks including but not limited to public, private, and wireless communication network. The computer(s) have access to a database, which includes information regarding the coupon, voucher, gift card, or credit card.

The information regarding the coupon typically stored in a flat file. Information in the flat file is generally separated. For example, the information can be tab delimited and comma delimited, if desired. The information corresponds to many different characteristics of the coupon such as the value, expiration date, product and/or service it is identified with etc. The product the coupon is identified with can be of many different types, such as a grocery product (i.e. milk) and clothing merchandise (i.e. a shirt). The service the coupon is identified with can be of many different types, such as a haircut or carwash. The coupon value corresponds with the discount or payment amount at which the coupon can be redeemed for at the intended merchant. The coupon expiration date is the date at which the coupon expires and is no longer redeemable.

In operation, the information corresponding to one or more coupons is entered into a database. The information corresponding to the coupon(s) can be entered into the database in many different ways, such as by flowing the information of the flat file to the database through an application server. Alternatively, information can be retrieved directly from the issuing merchant. The application server is typically run on the computer(s) mentioned above. The application server can validate the flat file by processing and checking the flat files data structure prior to integrating the information into the database. After the flat files data structure has been validated, the flat files coupon feed is then incorporated into the database.

It should be noted that the coupon expiration date is generally included as part of the flat files record and is used to age and expire a coupon. It should also be noted that only coupons with designated future expiration dates, as compared to the applications system date, will be available for end user viewing and use. In this way, coupons that have expired will not be available for redemption.

In operation, a user will typically be required to establish an account with an application server prior to being able to use any active coupons. The account includes information regarding the user, which could include a unique device ID, geographic information, or name and contact information. Examples of contact information include the user's address, phone number, e-mail address, etc. The process of establishing the account is typically referred to as registration. The application server allows the user to view and obtain coupons in response to establishing the account, as described above. Additionally, the application server allows for coupons to be distributed by two methods push or pull. An example of the push method is where a user comes within physical proximity to a communication network with a corresponding application server which then “pushes” a single or multiple predetermined digital coupons to the users mobile device; the application server could determine which digital coupon to distribute based on the users behaviors, time, or geographic location. An example of the pull method is where a user comes within physical proximity to a communication network with a corresponding application server which allows the user to filter through a list of available digital coupons and “pull” their desired selection to their mobile device for use.

It is desirable to require the user to establish an account so that his or her habits can be tracked. For example, the products and services purchased, time of coupon use, location of coupon use, type and amount of coupons that the user redeems can be tracked. It is desirable to track the type and amount of coupons redeemed by the user to reduce the user's ability to abuse the coupon redemption system. For example, it is desirable to track the type and amount of coupons redeemed by the user to reduce the user's ability to redeem multiple coupons for the same product. User site actions including keyword search, browse, and viewing histories are logged and tracked for reporting and marketing purposes.

In some embodiments, coupon viewing is tracked and limited based on unique user profiles. For example, the user profile can have a coupon view number associated with it. Once the user has viewed a number of coupons corresponding to the coupon view number, his or her ability to view more coupons is restricted. For example, in some situations, the user's ability to view coupons associated with milk is restricted in response to the user viewing five coupons corresponding with milk. In this example, the coupon view number corresponds with five. It should be noted that the coupon view number can have many different number values, and generally has a number value in a range greater than or equal to zero.

The application server typically sets and establishes the coupon view number and coupon viewing thresholds can be configured per coupon, per user account, and/or per marketing campaign. However, in some embodiments, the user can request to view a coupon through the use of a web enabled mobile device or a Personal Computer (PC). A user request to view an active useable coupon can be processed in many different ways. In one embodiment, the user request to view an active useable coupon is processed as follows. A coupon to be viewed is selected by a user. The application server processes the request by checking to see how to handle the request. If the database has an ASCII coupon code, the text will be pulled into the application server for the users display and use. If the database has a barcode type selected, a script will be used to translate the requested coupon into a viewable barcode image file. The barcode image file is stored locally in a temporary location on the application server. The user is presented a coupon barcode image through the web application referencing the temporary image location. The application server appropriately sizes the barcode image based on the user's environmental variables including web browser and mobile devices operating system, if applicable.

The information regarding the voucher or gift card is typically stored and maintained by the issuing merchant or card issuer. Information on the card is generally read, validated, and redeemed as payment by the issuing merchant or card issuer's point of sale system. For example, the voucher or gift card information can contain a barcode with account number, expiration date, and account balance, if desired. This information is then typically read by a barcode reader at a point of sale system an reconciled against account information such as voucher or gift card balance, which is maintained by the issuing merchant or card issuers point of sale system.

In operation, the information corresponding to a voucher or gift card is entered into a database. The information corresponding to the voucher or gift card can be entered into the database in many different ways, such as by flowing the information of the flat file to the database through an application server. Alternatively, information on the voucher or gift card can be retrieved directly from the issuing merchant. The application server is typically run on the computer(s) mentioned above. The application server can validate the flat file by processing and checking the flat files data structure prior to integrating the information into the database. After the flat files data structure has been validated, the flat files voucher/gift card feed is then incorporated into the database.

It should be noted that the voucher/gift card expiration date and account balance is generally included as part of the flat files record and is used to age and expire a voucher or gift card. It should also be noted that only active vouchers or gift cards with designated future expiration dates, as compared to the applications system date, or with positive balances greater than zero will be available for voucher/gift card holders use. In this way, vouchers or gift cards that have expired or been depleted of funds will not be available for redemption.

In operation, a voucher or gift card holders will typically be required to activate their cards with an application server prior to being able to use any available funds. Each voucher or gift card.

In operation, a voucher or gift cards digital barcode and information can be issued and distributed electronically to a mobile device based on credit card points or reward systems. Such prepaid vouchers or gift cards rewards could be issued directly from the rewards provider or indirectly through use of a third party servicer. These prepaid vouchers or gift cards would then be redeemed by scanning the mobile devices display with a barcode reader and tracked via the issuing merchant's point of sale system.

The information regarding the credit card is typically stored and maintained by the card issuer or the credit issuing financial institution. Information on the credit card is generally read, verified, and authorized as payment by the card issuer's credit card reader, which communicates with a merchant's point of sale system to redeem payment on the account holder's behalf.

In operation, the information corresponding to a credit card is encoded into a unique one-time use digital barcode each time a payment is requested to be made. The information corresponding to the credit card can be entered into the digital barcode in many different ways, such as by encrypting the account information and transposing the encrypted data into a digital 2D barcode schema for scanning and use as payment. The barcode can then be distributed or generated on a mobile devices display and scanned by the merchant's barcode reader or the card issuer's credit card reader for payment processing.

In accordance with the invention, the barcode image will be displayed by the display screen in such a way that it conforms to the specifications discussed above. In particular, the size and resolution of the barcode image is adjusted in response to an indication of the type of display screen so that the barcode image can be displayed in a manner in which it can be read by the scanning device. The indication of the type of display screen is generally a signal which is flowed from the electronic device to the application server.

There are many different ways in which the barcode image can be displayed with the display screen. Examples of some ways include image file format, Vector Graphics, Metafile and Page Description Language. The way in which the barcode image is displayed by the display screen depends on many different factors, such as the type of electronic device, the type of display screen, as well as the electronic device operating system.

In some embodiments data is encrypted and transposed into a barcode for security and use. In some embodiments, after a set duration of time, the barcode image is deleted from the temporary storage location on the application server and is no longer available for use. In some embodiments, after a set duration of time, the barcode image is deleted from the database and is no longer available for use. In some embodiments, after a set duration of time, the barcode image is deleted from the electronic device and is no longer available for use. Deleting the barcode image from the electronic device is useful so that the user is restricted from abusing the redemption system by using the barcode multiple times.

There are many different methods for redeeming the coupon, gift card, voucher, or credit card. One method for redeeming the coupon, gift card, voucher, or credit card is referred to as image scanning redemption. Image scanning redemption refers to physically presenting the electronic device, with the barcode image rendered on the display screen, to a merchant point of sale (POS) system and using the merchant's barcode scanner to read the displayed barcode image from the display screen. For example, in some situations, the bar code image is redeemed by reading the barcode image from the display screen using the scanning device, wherein the scanning device is in communication with the POS system. Examples of POS systems are disclosed in some of the references mentioned above. Other examples of POS systems can be found in U.S. Pat. Nos. 7,406,438, 5,179,375, 4,937,744, 4,734,857, 4,204,636, as well as in U.S. Patent Application No. 20030233276, the contents of all of which are incorporated herein by reference.

Another method for redeeming the coupon, gift card, voucher, or credit card is referred to as manual Key/Verbal redemption. Manual Key/Verbal redemption refers to physically presenting the display screen or coupon print outs to a merchant point of sale system and manually having the numeric or ASCII characters keyed into the POS system. For example, in some situations, the coupon, gift card, voucher, or credit card is redeemed by reading the barcode code from the display screen and entering the code into a Point of Sale (POS) system. Examples of POS systems include a cash register and a computer that operates as a cash register. Redeeming the coupon by reading the barcode from the display screen and entering the code into the POS system is useful if the barcode image cannot be read by the scanning device.

It should be noted that the coupon, voucher, gift card, and credit card redemption system, as described above, is a network-based coupon, voucher, gift card, and credit card distribution system because it utilizes a network based application server(s). Access to the network based coupon, voucher, gift card, and credit card distribution system and digital coupons can be achieved wirelessly through either a mobile devices web browser or a local application specific to the mobile device. For example, the local application can wirelessly connect to a network and receive digital coupon, voucher, gift card, or credit card either through a push, select digital coupons are send to the user without option to select, or pull, where the user has choice and the ability to filter for a desired digital coupon, voucher, gift card, or credit which can be redeemed in a predetermined geographical location or at a predetermined time/date.

It should be noted that wireless communications can include but are not limited to radio, infrared, laser, and Bluetooth channels. In one situation, the electronic device has the capability of determining its Global Positioning System (GPS) coordinates to search for coupons that can be redeemed in a region which includes the GPS coordinates. The region which includes the GPS coordinates can be set by the user, if desired. For example, the user can specify that he or she wants to search for coupons that are redeemable within 5 miles of the GPS coordinates. In another example, the user or provider of digital coupons can specify that he or she wants to coupons that are redeemable within 10 miles of the GPS coordinates or within a specific merchants store, wherein the coupons are identified with a desired product or service. In this way, the GPS ability of the electronic device or the application server can be used to locate softcopies of coupons for desired geographical regions.

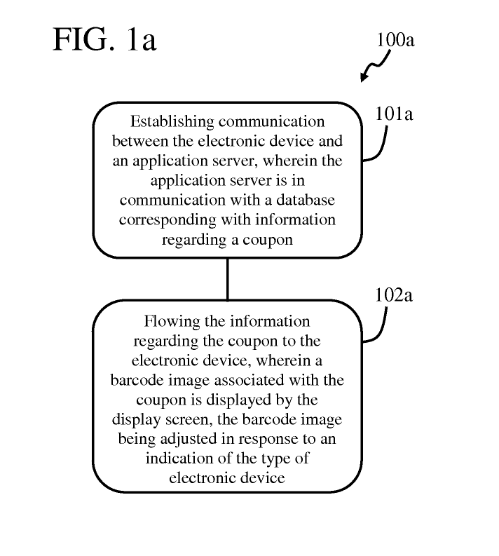

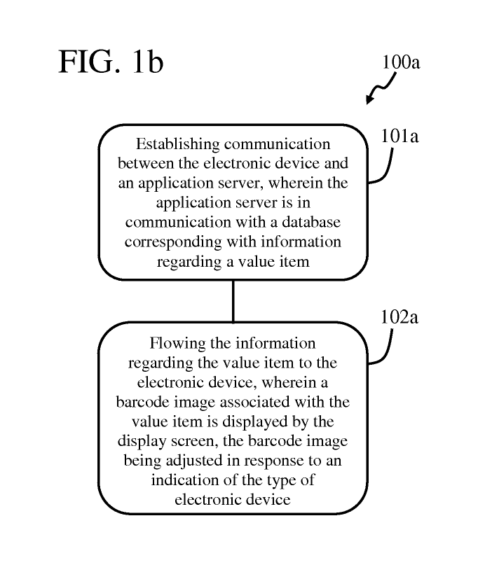

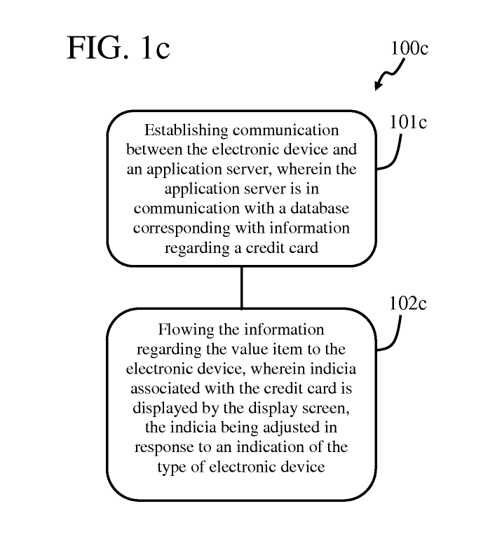

FIG. 1 is a flow diagram of a method 100 of displaying an image with a display screen of an electronic device. In this embodiment, method 100 includes a step 101 of establishing communication between the electronic device and an application server, wherein the application server is in communication with a database corresponding with information regarding a coupon and a step 102 of flowing the information regarding the coupon to the electronic device, wherein a barcode image associated with the coupon is displayed by the display screen, the barcode image being adjusted in response to an indication of the type of electronic device.

In some embodiments, method 100 includes adjusting the size of the barcode image in response to an indication of the type of electronic device.

In some embodiments, the information is flowed in response to an indication of a time. In some embodiments, the information is flowed in response to an indication of a time indication provided by the electronic device.

In some embodiments, the information is flowed in response to an indication of a location. In some embodiments, the information is flowed in response to an indication of a location indication provided by the electronic device.

In some embodiments, the information is flowed in response to an indication of a behavior.

In some embodiments, the application server is in communication with a database corresponding with information regarding a gift card. In these embodiments, the gift card includes a bar code which can be displayed by the display screen.

In some embodiments, the application server is in communication with a database corresponding with information regarding a voucher. In these embodiments, the voucher includes a bar code which can be displayed by the display screen.

In some embodiments, the application server is in communication with a database corresponding to an image of a credit card. In these embodiments, information corresponding to the credit card is displayed by the display screen.

FIG. 1a is a flow diagram of a method 100a of displaying an image with a display screen of an electronic device. In this embodiment, method 100a includes a step 101a of establishing communication between the electronic device and an application server, wherein the application server is in communication with a database corresponding with information regarding a coupon. Method 100a includes a step 102a of flowing the information regarding the coupon to the electronic device, wherein a barcode image associated with the coupon is displayed by the display screen, the barcode image being adjusted in response to an indication of the type of electronic device.

In some embodiments, method 100a includes adjusting the size of the barcode image in response to an indication of the type of electronic device.

In some embodiments of method 100a, the information is flowed in response to an indication of a time. In some embodiments, the information is flowed in response to an indication of a time indication provided by the electronic device.

In some embodiments of method 100a, the information is flowed in response to an indication of a location. In some embodiments, the information is flowed in response to an indication of a location indication provided by the electronic device.

In some embodiments of method 100a, the information is flowed in response to an indication of a behavior.

In some embodiments of method 100a, the application server is in communication with a database corresponding with information regarding a gift card. In these embodiments, the gift card includes a bar code which can be displayed by the display screen.

In some embodiments of method 100a, the application server is in communication with a database corresponding with information regarding a voucher. In these embodiments, the voucher includes a bar code which can be displayed by the display screen.

In some embodiments of method 100a, the application server is in communication with a database corresponding to an image of a credit card. In these embodiments, information corresponding to the credit card is displayed by the display screen.

FIG. 1b is a flow diagram of a method 100b of displaying an image with a display screen of an electronic device. In this embodiment, method 100b includes a step 101b of establishing communication between the electronic device and an application server, wherein the application server is in communication with a database corresponding with information regarding a value item. The value item can be of many different types, such as a coupon, voucher, gift card and credit card, among others.

Method 100b includes a step 102b of flowing the information regarding the value item to the electronic device, wherein a barcode image associated with the value item is displayed by the display screen, the barcode image being adjusted in response to an indication of the type of electronic device.

In some embodiments, method 100b includes adjusting the size of the barcode image in response to an indication of the type of electronic device.

In some embodiments of method 100b, the information is flowed in response to an indication of a time. In some embodiments, the information is flowed in response to an indication of a time indication provided by the electronic device.

In some embodiments of method 100b, the information is flowed in response to an indication of a location. In some embodiments, the information is flowed in response to an indication of a location indication provided by the electronic device.

In some embodiments of method 100b, the information is flowed in response to an indication of a behavior.

FIG. 1c is a flow diagram of a method 100c of displaying an image with a display screen of an electronic device. In this embodiment, method 100c includes a step 101c of establishing communication between the electronic device and an application server, wherein the application server is in communication with a database corresponding with information regarding a credit card.

Method 100c includes a step 102c of flowing the information regarding the credit card to the electronic device, wherein indicia associated with the credit card is displayed by the display screen, the indicia being adjusted in response to an indication of the type of electronic device. The indicia can be of many different types, such as a bar code, letters and/or numbers, among others.

In some embodiments, method 100c includes adjusting the size of the indicia in response to an indication of the type of electronic device.

In some embodiments of method 100c, the information is flowed in response to an indication of a time. In some embodiments, the information is flowed in response to an indication of a time indication provided by the electronic device.

In some embodiments of method 100c, the information is flowed in response to an indication of a location. In some embodiments, the information is flowed in response to an indication of a location indication provided by the electronic device.

In some embodiments of method 100c, the information is flowed in response to an indication of a behavior.

The embodiments of the invention described herein are exemplary and numerous modifications, variations and rearrangements can be readily envisioned to achieve substantially equivalent results, all of which are intended to be embraced within the spirit and scope of the invention.

1. A method of displaying an image with a display screen of an electronic device, comprising:
establishing communication between the electronic device and an application server, wherein the application server is in communication with a database corresponding with information regarding a coupon; and
flowing the information regarding the coupon to the electronic device, wherein a barcode image associated with the coupon is displayed by the display screen, the barcode image being adjusted in response to an indication of the type of electronic device.

2. The method of claim 1, further including adjusting the size of the barcode image in response to an indication of the type of electronic device.

3. The method of claim 1, wherein the information is flowed in response to an indication of a time.

4. The method of claim 1, wherein the information is flowed in response to an indication of a time indication provided by the electronic device.

5. The method of claim 1, wherein the information is flowed in response to an indication of a location.

6. The method of claim 1, wherein the information is flowed in response to an indication of a location indication provided by the electronic device.

7. The method of claim 1, wherein the information is flowed in response to an indication of a behavior.

8. The method of claim 1, wherein the application server is in communication with a database corresponding with information regarding a gift card.

9. The method of claim 8, wherein a barcode of the gift card is displayed by the display screen.

10. The method of claim 1, wherein the application server is in communication with a database corresponding with information regarding a voucher.

11. The method of claim 10, wherein a barcode of the voucher is displayed by the display screen.

12. The method of claim 1, wherein the application server is in communication with a database corresponding an image of a credit card.

13. The method of claim 12, wherein information corresponding to the credit card is displayed by the display screen.

14. The method of redeeming a gift card with a display screen of an electronic device, comprising:
flowing the information regarding the gift card to the point of sale system, wherein a barcode image associated with the gift card is displayed by the display screen of an electronic device, the barcode image being scanned by a barcode reader in response to an indication of a payment.

15. The method of claim 14, wherein a barcode of the voucher is displayed by the display screen.

16. The method of claim 14, wherein a barcode of the credit card is displayed by the display screen.

17. The method of redeeming a coupon with a display screen of an electronic device, comprising:
flowing the information regarding the coupon to the point of sale system, wherein a barcode image associated with the coupon is displayed by the display screen of an electronic device, the barcode image being scanned by a barcode reader in response to an indication of a financial discount.

18. The method of claim 17, wherein a barcode of the coupon is scanned by a barcode reader in response to an indication of benefit.
